(19) United States
(12) Patent Application Publication
(10) Pub. No.: US 2009/0295940 A1
(43) Pub. Date: Dec. 3, 2009

(54) Interchangeable Lens, Camera Body, and Imaging Apparatus

(75) Inventor: Koji Shibuno, Osaka (JP)

Correspondence Address: PANASONIC PATENT CENTER, 1130 CONNECTICUT AVENUE NW, SUITE 1100, WASHINGTON, DC, 20036, US

(73) Assignee: PANASONIC CORPORATION, Osaka (JP)

(21) Appl. No.: 12/427,879

(22) Filed: Apr. 22, 2009

(30) Foreign Application Priority Data
Apr. 23, 2008 (JP) 2008-112343

(51) Int. Cl. H04N 9/73; G03B 17/00; G02B 15/14; H04N 5/225

(52) U.S. Cl. 348/226.1; 396/529; 359/676; 348/340; 348/E05.024; 348/E09.051

(57) ABSTRACT

There are provided a camera body, an interchangeable lens, and an imaging apparatus that enable to perform appropriate exposure control even when the zoom magnification is changed by a user after the camera body sets the diaphragm value of the interchangeable lens. The interchangeable lens, which includes a diaphragm and a movable lens and is mountable to a camera body, have a request signal receiving unit that receives a request signal requesting to send information on brightness of the interchangeable lens, the request signal being sent from the camera body on a frame-by-frame basis; a brightness information calculating unit that calculates information on brightness of the interchangeable lens based on states of the diaphragm and the movable lens when the request signal receiving unit receives the request signal; and a brightness information sending unit that sends the calculated information on brightness of the interchangeable lens to the camera body.

### BACKGROUND

1. Technical Field

The technical field relates to an interchangeable lens mountable to a camera body, a camera body to which an interchangeable lens is mountable, and an imaging apparatus including the interchangeable lens and the camera body.

2. Related Art

Conventionally, imaging apparatuses have been used such as single-lens reflex cameras that generate a still image by mounting an interchangeable lens to a camera body and capturing a subject image. In a conventional imaging apparatus, when an exposure state is controlled, a still camera body provides an instruction for brightness (e.g., a diaphragm value) to an interchangeable lens and the interchangeable lens adjusts the aperture of a diaphragm and the like, to obtain the instructed brightness. Also, as described in the patent document 1, there exists an imaging apparatus that generates a moving image by mounting an interchangeable lens for a single-lens reflex camera on a video camera body and capturing a subject image. The imaging apparatus described in the patent document 1 has an adapter provided between the video camera body and the interchangeable lens for the single-lens reflex camera. The adapter determines an amount of drive and drive speed of a diaphragm of the interchangeable lens, according to a difference between a target video signal level sent from the video camera body and a video signal level detected by the interchangeable lens.

Patent document 1: JP-A-2006-215310

In a conventional imaging apparatus, an exposure adjustment of a camera body and an interchangeable lens is made before shooting starts. Specifically, as shown in FIG. 15, before shooting starts, the camera body sends the interchangeable lens a control signal for adjusting exposure (e.g., the diaphragm value “F8”) and the interchangeable lens adjusts, based on the received control signal, a diaphragm provided in the interchangeable lens to obtain the diaphragm value “F8”. Also, the camera body performs exposure control of an imaging unit and the like provided in the camera body, based on the specified diaphragm value “F8”. The conventional imaging apparatus controls an exposure state in this manner. The brightness of the interchangeable lens changes depending on the aperture of the diaphragm or the position of a zoom lens (zoom position) provided in the interchangeable lens. Hence, when a user changes the zoom magnification by manually operating a zoom ring of the interchangeable lens, the brightness of the interchangeable lens changes. Specifically, for example, in FIG. 15, after the exposure of the interchangeable lens and the camera body is adjusted based on the diaphragm value “F8”, when the user changes the zoom magnification of the interchangeable lens by operating the zoom ring of the interchangeable lens, the position of the zoom lens changes. As a result, an amount of light striking an imaging element provided to the camera body changes. That is, the brightness of the interchangeable lens changes and thus the diaphragm value changes to “F11”, for example. However, since the camera body cannot detect that the diaphragm value has been changed on the interchangeable lens side, imaging is performed with such imaging conditions (e.g., sensitivity and imaging time) that are set for the diaphragm value “F8”. Accordingly, there is a problem that if the diaphragm value is changed on the interchangeable lens side when image data is continuously generated, such as during moving-image shooting, then the camera body cannot perform appropriate exposure control of the imaging element to generate moving-image data.

As such, the conventional imaging apparatus has a problem that, for plural pieces of image data which are sequentially generated by the imaging element (e.g., during moving-image shooting), when the zoom lens is manually operated, appropriate exposure control of the imaging element cannot be performed. Specifically, there is a problem that when the zoom magnification is changed by the user after the camera body sets the diaphragm value of the interchangeable lens, appropriate exposure control cannot be performed.

### SUMMARY

To solve the aforementioned problems, an object is therefore to provide a camera body that enables to perform appropriate exposure control of an imaging element for plural pieces of image data which are sequentially generated by the imaging element, an interchangeable lens mountable to the camera body, and an imaging apparatus including such a camera body and an interchangeable lens. Specifically, an object is to provide a camera body, an interchangeable lens, and an imaging apparatus that enable to perform appropriate exposure control even when the zoom magnification is changed by a user after the camera body sets the diaphragm value of the interchangeable lens.

An interchangeable lens according to one aspect is mountable to a camera body that includes an imaging unit operable to capture a subject image. The interchangeable lens includes: a diaphragm; a movable lens; a request signal receiving unit operable to receive a request signal from the camera body; a brightness information calculating unit operable to calculate information on brightness of the interchangeable lens based on states of the diaphragm and the movable lens when the request signal receiving unit receives the request signal; and a brightness information sending unit operable to send the calculated information on brightness of the interchangeable lens to the camera body. The request signal is a signal that is sequentially transmitted from the camera body in accordance with capture timing of the imaging unit.

According to the above configurations, the camera body sends, to the interchangeable lens, a request signal requesting to send information on the brightness of the interchangeable lens in accordance with capture timing of the imaging unit (for example, on a frame-by-frame basis), and, in response to the request signal, the interchangeable lens sends information on the brightness of the interchangeable lens to the camera body. Thus, appropriate exposure control can be performed even when, after the camera body sends a control signal for adjusting exposure (e.g., a diaphragm value) to the interchangeable lens, the zoom magnification is changed by the user performing an operation on the interchangeable lens, causing the diaphragm value to be changed. That is, exposure control of the imaging element can be smoothly performed for plural pieces of image data which are sequentially generated by the imaging element.

### BRIEF DESCRIPTION OF THE DRAWINGS

FIG. 1 is a perspective view of a digital camera according to an embodiment.

FIG. 2 is a block diagram showing a configuration of the digital camera according to the embodiment.

FIG. 3 is a diagram showing a diaphragm value table for the digital camera according to the embodiment.

FIG. 4 is a functional block diagram of a CPU of a camera body and a lens controller of an interchangeable lens according to the embodiment.

FIG. 5 is a diagram showing a sequence of sending of a diaphragm value send request and a diaphragm value between the camera body and the interchangeable lens according to the embodiment.

FIG. 6 is a flowchart showing the flow of exchange of data between the camera body and the interchangeable lens according to the embodiment.

FIG. 7 is a flowchart of an automatic exposure adjustment operation of the digital camera according to the embodiment.

FIG. 8 is a flowchart of an automatic exposure adjustment operation of the digital camera according to the embodiment.

FIG. 9 is a flowchart of an automatic exposure adjustment operation of the digital camera according to the embodiment.

FIG. 10 is a flowchart of an automatic exposure adjustment operation of the digital camera according to the embodiment.

FIG. 11 is a flowchart of an automatic exposure adjustment operation of the digital camera according to the embodiment.

FIG. 12 is a flowchart of an automatic exposure adjustment operation of the digital camera according to the embodiment.

FIG. 13 is a flowchart of a manual exposure adjustment operation of the digital camera according to the embodiment.

FIG. 14 is a diagram showing an example of a display screen provided when the diaphragm value is changed on the digital camera according to the embodiment.

FIG. 15 is a diagram showing control of the diaphragm value on a conventional camera.

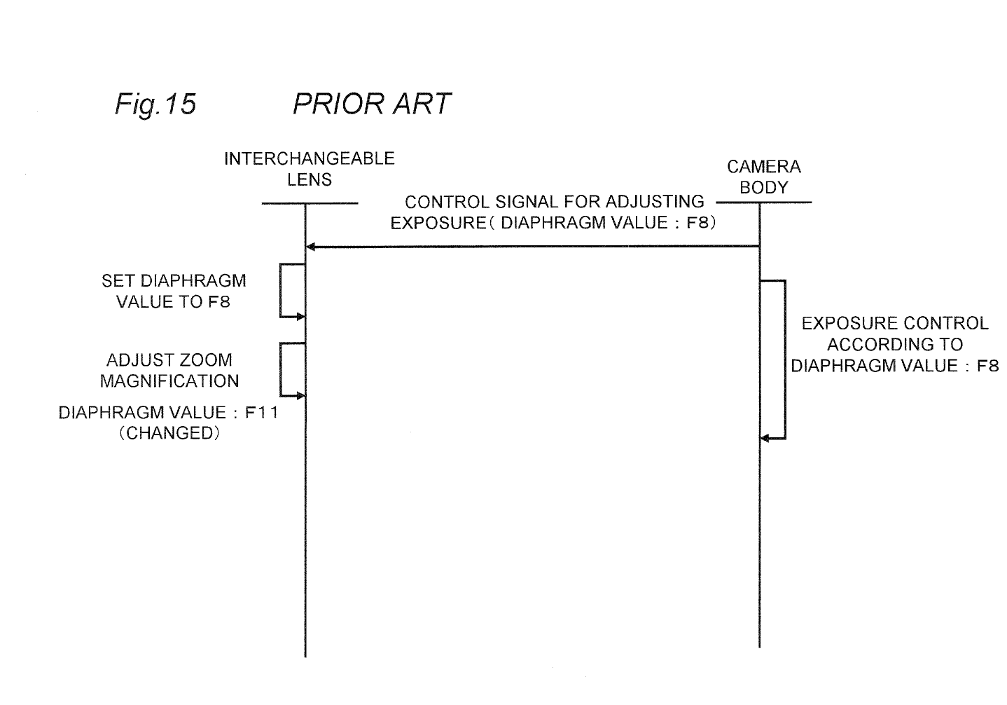

FIG. 16 is a flowchart of an automatic exposure adjustment operation of the digital camera according to the embodiment.

FIG. 17 is a flowchart of an automatic exposure adjustment operation of the digital camera according to the embodiment.

### DETAILED DESCRIPTION OF THE PREFERRED EMBODIMENTS

An embodiment will be described below with reference to the accompanying drawings. In the present embodiment, an imaging apparatus is a digital single-lens camera (hereinafter, simply referred to as the “digital camera”). In the digital camera according to the present embodiment, a request signal requesting for information on brightness is sent from a camera body to an interchangeable lens on a frame-by-frame basis. This enables appropriate exposure control by the camera body, even when the brightness of the interchangeable lens is changed by a user changing the zoom magnification on the interchangeable lens side.

### 1. Configuration

### 1-1 Overall Configuration

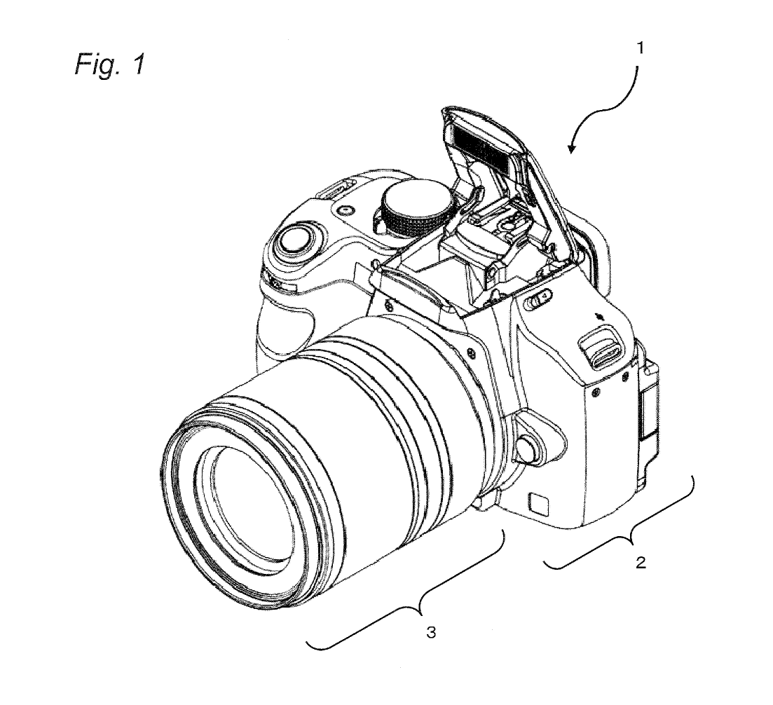

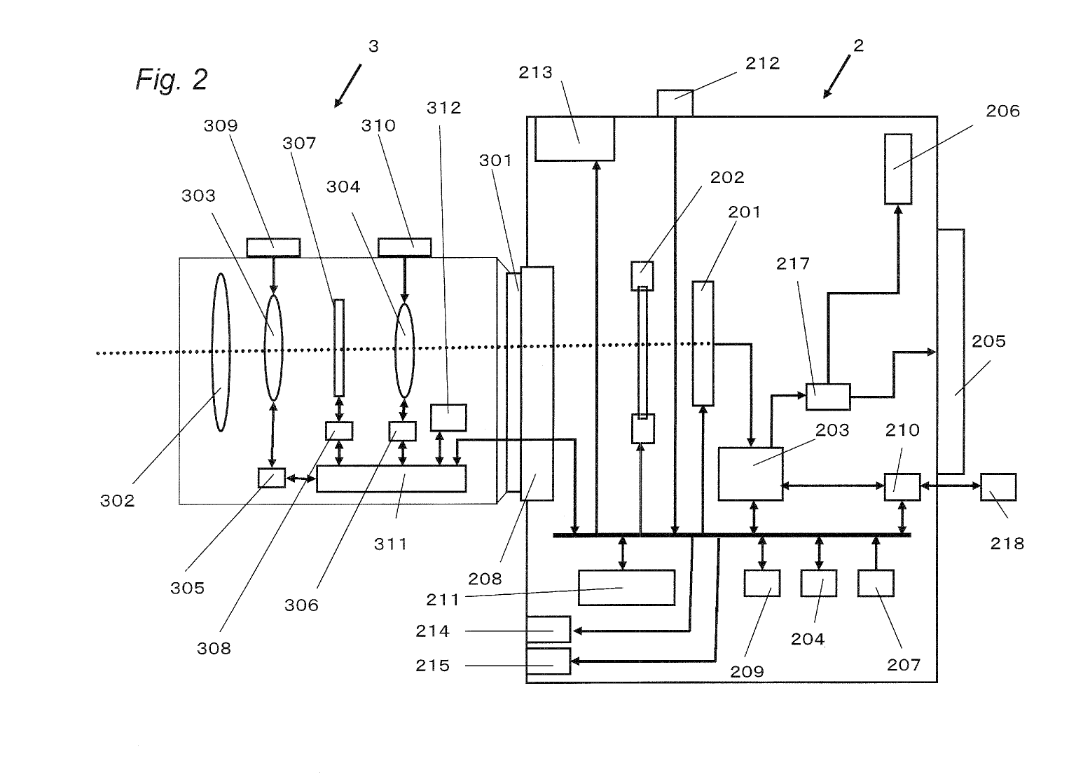

FIG. 1 is a perspective view of a digital camera 1 according to an embodiment. The digital camera 1 according to the present embodiment includes a camera body 2 and an interchangeable lens 3 mountable to the camera body 2. The camera body 2 captures a subject image where light is collected by an optical system of the interchangeable lens 3, and records the captured subject image as image data. The camera body 2 is configured to be able to send a control signal for exposure adjustment (i.e., information on brightness) to the interchangeable lens 3. In the present embodiment, the “information on brightness” is a “diaphragm value (F-number)”. Note that the information on brightness may be an AV (Aperture Value). FIG. 2 is a block diagram showing a specific configuration of the digital camera 1 in FIG. 1.

### 1-2 Configuration of Camera Body

The camera body 2 includes a CMOS sensor (CMOS image sensor) 201, a mechanical shutter 202, a signal processing processor 203 (DSP), a buffer memory 204, a liquid crystal monitor 205, an electronic viewfinder 206 (EVF), a power supply 207, a body mount 208, a flash memory 209, a card slot 210, a CPU 211, a shutter switch 212, a electronic flash 213, a microphone 214, and a speaker 215.

The CMOS sensor 201 is an imaging unit that captures a subject image to generate image data (a digital signal or electrical signal). The CMOS sensor 201 includes a light-receiving element (imaging element), an AGC (gain control amplifier), and an AD converter. The light-receiving element converts an optical signal obtained by collecting light by the optical system of the interchangeable lens 3, into an electrical signal. The AGC amplifies the electrical signal outputted from the light-receiving element. The AD converter converts the electrical signal outputted from the AGC into a digital signal.

The CMOS sensor 201 performs various operations such as exposure, transfer, and an electronic shutter operation, according to a control signal sent from the CPU 211. The various operations can be implemented by a built-in timing generator, and so on. The operation of the CMOS sensor 201 includes capturing of still images and moving images, and the like. The moving image generated by the CMOS sensor 201 is, for example, displayed on the liquid crystal monitor 205. This moving image displayed on the liquid crystal monitor 205 is referred to as “a through image”. The through image is an image for a user determining a composition upon capturing a still image. The moving image generated by the CMOS sensor 201 is, for example, recorded in the memory card 218. The moving image recorded in the storage medium such as the memory card 218 is referred to as “a moving image for recording”. An electronic shutter adjusts the light-receiving time (imaging time) per frame of the light-receiving element.

The mechanical shutter 202 switches between cutoff and transmission of an optical signal to the CMOS sensor 201, which enters through the optical system of the interchangeable lens 3. The mechanical shutter 202 opens and closes to temporally adjust the amount of light incident on the CMOS sensor 201. The mechanical shutter 202 is driven by a mechanical shutter drive unit (not shown). The mechanical shutter drive unit is configured by electromechanical components such as a motor and a spring, and drives the mechanical shutter 202 according to control by the CPU 211.

The signal processing processor (DSP) 203 performs predetermined image processing on image data which is converted into a digital signal by the AD converter. The predetermined image processing includes gamma conversion, YC conversion, an electronic zoom process, a compression process, a decompression process, and so on.

The buffer memory 204 acts as a work memory when the signal processing processor 203 performs a process and when the CPU 211 performs a control process. The buffer memory 204 is, for example, a DRM.

The liquid crystal monitor 205 is disposed on the back of the camera body 2 and displays image data generated by the CMOS sensor 201 or image data obtained by performing a predetermined process on the image data. An image signal to be inputted to the liquid crystal monitor 205 is converted from a digital signal into an analog signal by a DA converter when outputted from the signal processing processor 203 to the liquid crystal monitor 205.

The electronic viewfinder 206 is disposed in the camera body 2 and displays image data generated by the CMOS sensor 201 or image data obtained by performing a predetermined process on the image data. An image signal to be inputted to the electronic viewfinder 206 is also similarly converted from a digital signal into an analog signal by the DA converter when outputted from the signal processing processor 203 to the electronic viewfinder 206.

A display switching unit 217 switches display of an image signal between the liquid crystal monitor 205 and the electronic viewfinder 206. That is, while an image is displayed on the liquid crystal monitor 205, nothing is displayed in the electronic viewfinder 206. While an image is displayed in the electronic viewfinder 206, nothing is displayed on the liquid crystal monitor 205. The display switching unit 217 can be implemented by a physical structure such as a switching switch. In this case, for example, when the switching switch is switched with the signal processing processor 203 and the liquid crystal monitor 205 being electrically connected to each other, the electrical connection between the signal processing processor 203 and the liquid crystal monitor 205 is disconnected and the signal processing processor 203 and the electronic viewfinder 206 are electrically connected to each other. Note that the display switching unit 217 is not limited to a switching switch and can be any as long as it can switch display between the liquid crystal monitor 205 and the electronic viewfinder 206, based on a control signal from the CPU 211. Note also that although in the present embodiment switching is performed between display on the liquid crystal monitor 205 and display in the electronic viewfinder 206, display on the liquid crystal monitor 205 and display in the electronic viewfinder 206 may be simultaneously performed. In the case of simultaneous display, an image displayed on the liquid crystal monitor 205 and an image displayed in the electronic viewfinder 206 may be the same or may be different.

The power supply 207 supplies power to be consumed by the digital camera 1. The power supply 207 may be, for example, a dry cell battery or rechargeable battery. Alternatively, the power supply 207 may supply power supplied from an external source through a power cord, to the digital camera 1.

The body mount 208 is a member that allows attachment and detachment of the interchangeable lens 3 through a lens mount 301 of the interchangeable lens 3. For example, the body mount 208 can be electrically connected to the interchangeable lens 3 by a connection terminal, and so on, and can be mechanically connected to the interchangeable lens 3 by a mechanical member such as an engaging member. The body mount 208 outputs a signal from a lens controller 311 of the interchangeable lens 3, to the CPU 211 and outputs a signal from the CPU 211 to the lens controller 311 of the interchangeable lens 3.

The flash memory 209 is a storage medium used as a built-in memory. The flash memory 209 stores image data or image data obtained by performing a predetermined process on the image data and a digitized audio signal. The flash memory 209 can further store programs, set values, and so on, for control by the CPU 211. An diaphragm value set by the user operating an operation member (not shown) which is provided to the camera body 2 and with which the diaphragm value can be adjusted, is stored in the flash memory 209.

The card slot 210 is a slot for allowing a memory card 218 to be inserted therein or removed therefrom. The memory card 218 is a storage medium that stores image data or image data obtained by performing a predetermined process on the image data and a digitized audio signal.

The CPU 211 controls the entire camera body 2. Also, the CPU 211 performs sending and receiving of a control signal, information on the optical system, and so on, with the lens controller 311 on the side of the interchangeable lens 3. The CPU 211 may be implemented by a microcomputer or may be implemented by a hard-wired circuit.

The shutter switch 212 is a button provided on a topside of the camera body 2 and is an operation unit that detects half-press and full-press operations from the user. When the shutter switch 212 accepts a half-press operation from the user, the shutter switch 212 outputs a half-press signal to the CPU 211. On the other hand, when the shutter switch 212 accepts a full-press operation from the user, the shutter switch 212 outputs a full-press signal to the CPU 211. Based on these signals, the CPU 211 performs various controls.

The electronic flash 213 irradiates light to a subject, based on a control signal from the CPU 211. For example, the electronic flash 213 can be implemented using a xenon lamp, a capacitor, and so on. In the case of this configuration, the electronic flash 213 irradiates light by accumulating high-voltage charge in the capacitor and applying the charge to an electrode of the xenon lamp.

The microphone 214 converts audio into an electrical signal. The electrical signal outputted from the microphone 214 is converted into a digital signal by the AD converter. The digital signal converted by the AD converter is stored in the flash memory 209 or the memory card 218, according to control by the CPU 211.

The speaker 215 converts an electrical signal into audio. An electrical signal to be inputted to the speaker 215 is a signal that is converted from a digital signal into an electrical signal by the DA converter. To the DA converter, a digital signal read from the flash memory 209 or the memory card 218 is inputted according to control by the CPU 211.

### 1-3 Configuration of Interchangeable Lens

The interchangeable lens 3 includes a lens mount 301, an objective lens 302, a zoom lens 303, a focus lens 304, a zoom drive unit 305 that drives the zoom lens 303, a focus drive unit 306 that drives the focus lens 304, a diaphragm 307, a diaphragm drive unit 308 that drives the diaphragm 307, a zoom ring 309, a focus ring 310, a lens controller 311, and a flash memory 312.

An optical system of the interchangeable lens 3 includes the objective lens 302, the zoom lens 303, and the focus lens 304 and collects light from a subject. The zoom drive unit 305 drives the zoom lens 303, according to control by the lens controller 311. The focus drive unit 306 drives the focus lens 304, according to control by the lens controller 311. The zoom ring 309 is provided on the exterior of the interchangeable lens 3 and drives the zoom lens 303, according to an operation performed by the user. The focus ring 310 is provided on the exterior of the interchangeable lens 3 and drives the focus lens 304, according to an operation performed by the user. The zoom lens 303 is driven by the zoom drive unit 305 or the zoom ring 309 to adjust the zoom magnification. The focus lens 304 is driven by the focus drive unit 306 or the focus ring 310 to adjust the focus. The zoom lens 303 and the focus lens 304 are movable lenses.

The diaphragm 307 adjusts the amount of light passing through the optical system. An adjustment to the amount of light is made by increasing or decreasing an aperture formed by five blades, for example. The diaphragm drive unit 308 changes the size of the aperture of the diaphragm 307, based on control by the lens controller 311. The size of the aperture can be specified by an F-number.

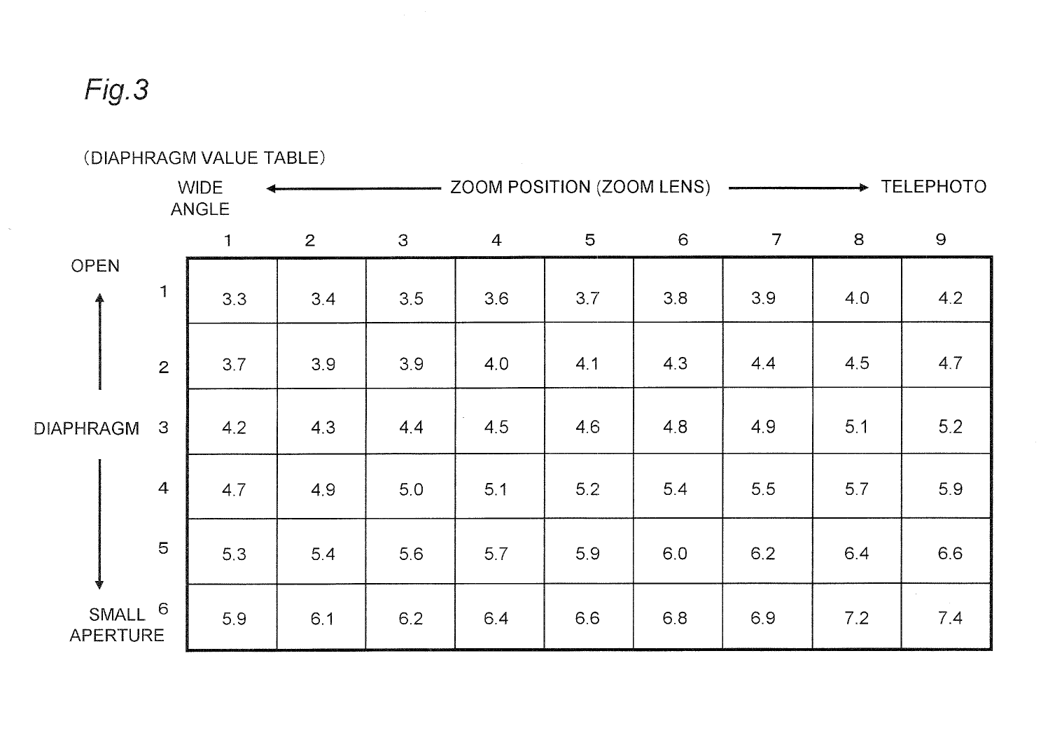

The flash memory 312 stores a diaphragm value table (described in detail later) shown in FIG. 3. The diaphragm drive unit 308 adjusts the size of the aperture of the diaphragm 307, based on a diaphragm value (F-number) specified by the camera body 2 and the diaphragm value table stored in the flash memory 312. Note that although the diaphragm drive unit 308 drives the diaphragm 307 based on control by the lens controller 311, the configuration is not limited thereto and the diaphragm 307 may be driven by a mechanical method. In this case, an interlocking pin is provided to the body mount 208 and the diaphragm drive unit 308 drives the diaphragm 307 responsive to drive of the interlocking pin. The interlocking pin is driven by a motor and the like controlled by the CPU 211.

The lens controller 311 controls the entire interchangeable lens 3. The lens controller 311 may be implemented by a microcomputer or may be implemented by a hard-wired circuit. The lens controller 311 controls sending of a diaphragm value of the interchangeable lens 3 to the camera body 2. The lens controller 311 calculates a diaphragm value, by referring to the diaphragm value table (FIG. 3) stored in the flash memory 312, based on a zoom position of the zoom lens 303 and an aperture of the diaphragm 307. The zoom position is determined, for example, according to a position of the zoom lens 303 in a movable range of the zoom lens 303.

A diaphragm value table used to calculate a diaphragm value of the interchangeable lens 3 will be described with reference to FIG. 3. The diaphragm value table is a table which relates a position of the zoom lens 303 (zoom position) and an aperture of the diaphragm 307 with a diaphragm value. The position of the zoom lens 303 is configured such that the closer it is to the wide-angle end the smaller the number corresponding to the zoom position is, and the closer it is to the telephoto end the greater the number corresponding to the zoom position is. The aperture is represented by a number of steps and is configured such that the smaller the step is the closer it is to the open side, and the greater the step is the closer it is to the small aperture side. By referring to the diaphragm value table and based on a zoom position and a diaphragm value, an aperture of the diaphragm required to adjust the diaphragm 307 can be calculated. The interchangeable lens 3 can adjust the diaphragm 307, by referring to the diaphragm value table, based on a control signal for exposure adjustment (including a diaphragm value) which is received from the camera body 2.

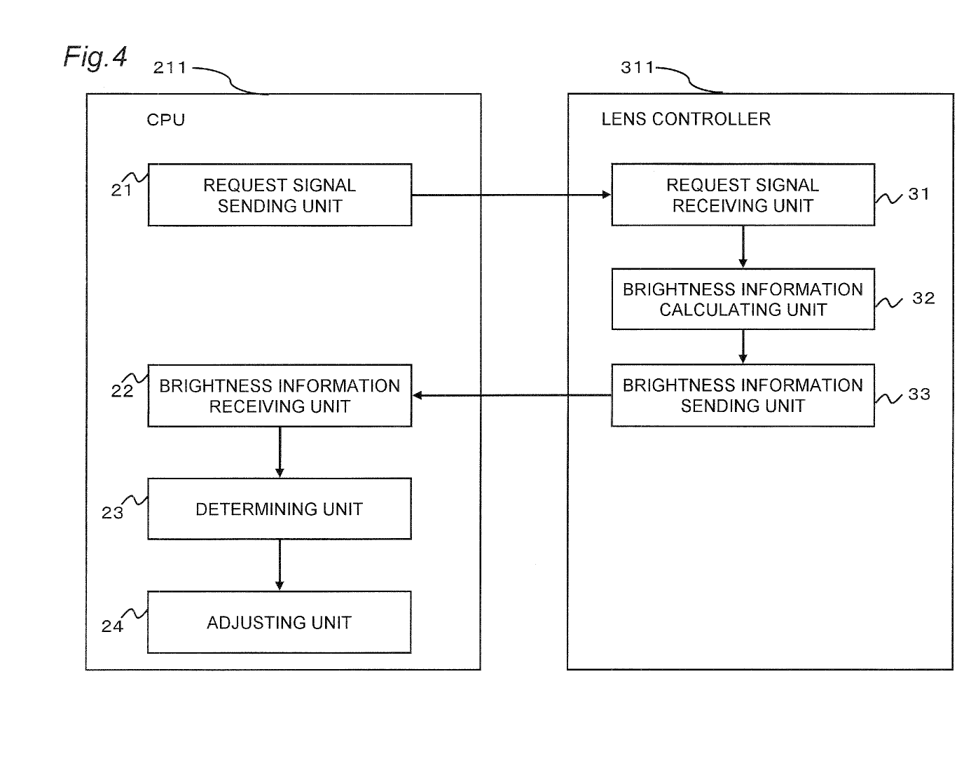

FIG. 4 is a functional diagram showing specific configurations of the CPU 211 of the camera body 2 and the lens controller 311 of the interchangeable lens 3.

### 1-4 Functions of CPU of Camera Body

The CPU 211 of the camera body 2 includes a request signal sending unit 21 that sends the lens controller 311 a request signal requesting to send information on the brightness of the interchangeable lens 3 (a diaphragm value (F-number) in the present embodiment); a brightness information receiving unit 22 that receives information on brightness sent from the lens controller 311; a determining unit 23 that determines whether a brightness indicated by the received information on brightness differs from an already set brightness; and an adjusting unit 24 that controls the interchangeable lens 3 or the camera body 2 according to a result of the determination made by the determining unit 23 and thereby adjusts an exposure state.

The request signal sending unit 21 sends the lens controller 311 a synchronizing signal indicating timing of the start of exposure of image data, as a request signal for requesting for information on brightness. Specifically, a synchronizing signal notifying about timing at which the CMOS sensor 201 obtains image data is sequentially sent to the lens controller 311 on a frame-by-frame basis. A synchronizing signal indicating timing of the start of exposure of image data is determined according to a vertical synchronizing (VD) signal from a timing generator. Note that instead of the CPU 211 sending a synchronizing signal indicating timing of the start of exposure of image data, the CPU 211 may send a synchronizing signal indicating timing of the end of exposure, as a request signal.

The brightness information receiving unit 22 obtains information on the brightness of the interchangeable lens 3 (specifically, a diaphragm value) sent from the lens controller 311. The brightness information receiving unit 22 stores the obtained information on a diaphragm value of the interchangeable lens 3 in the flash memory 209.

The determining unit 23 determines whether a brightness indicated by the obtained information on brightness differs from an already set brightness. Specifically, the determining unit 23 determines whether the obtained diaphragm value of the interchangeable lens 3 differs from the already set diaphragm value. Now, the “already set diaphragm value” will be described. When a diaphragm value is specified by the user operating the operation member of the camera body 2; the camera body 2 sends a control signal for adjusting an exposure state (including a diaphragm value) to the interchangeable lens 3 and also stores the diaphragm value in the flash memory 209 of the camera body 2. In the present embodiment, this diaphragm value stored in the flash memory 209 is referred to as the “already set diaphragm value”. The determining unit 23 compares a diaphragm value that is obtained from the interchangeable lens 3 in response to a request signal, with the already set diaphragm value stored in the flash memory 209 to determine whether the obtained diaphragm value of the interchangeable lens 3 differs from the already set diaphragm value.

If the determining unit 23 determines that the diaphragm value of the interchangeable lens 3 obtained from the lens controller 311 differs from the already set diaphragm value stored in the flash memory 209, then the adjusting unit 24 performs various operations for exposure adjustment. For example, the adjusting unit 24 causes the interchangeable lens 3 to adjust the diaphragm 307 to obtain the already set diaphragm value, or adjusts the shooting conditions of the CMOS sensor 201 of the camera body 2 such that the shooting conditions are suitable for the obtained diaphragm value of the interchangeable lens 3.

### 1-5 Functions of Lens Controller of Interchangeable Lens

The lens controller 311 of the interchangeable lens 3 includes a request signal receiving unit 31 that receives a request signal for requesting for information on brightness; a brightness information calculating unit 32 that calculates information on brightness (a diaphragm value in the present embodiment) in response to the received request signal; and a brightness information sending unit 33 that sends the calculated information on brightness to the CPU 211 of the camera body 2. The brightness information calculating unit 32 calculates a diaphragm value based on a zoom position of the zoom lens 303 and an aperture of the diaphragm 307 by referring to a diaphragm value table.

### 2. Operation of Digital Camera

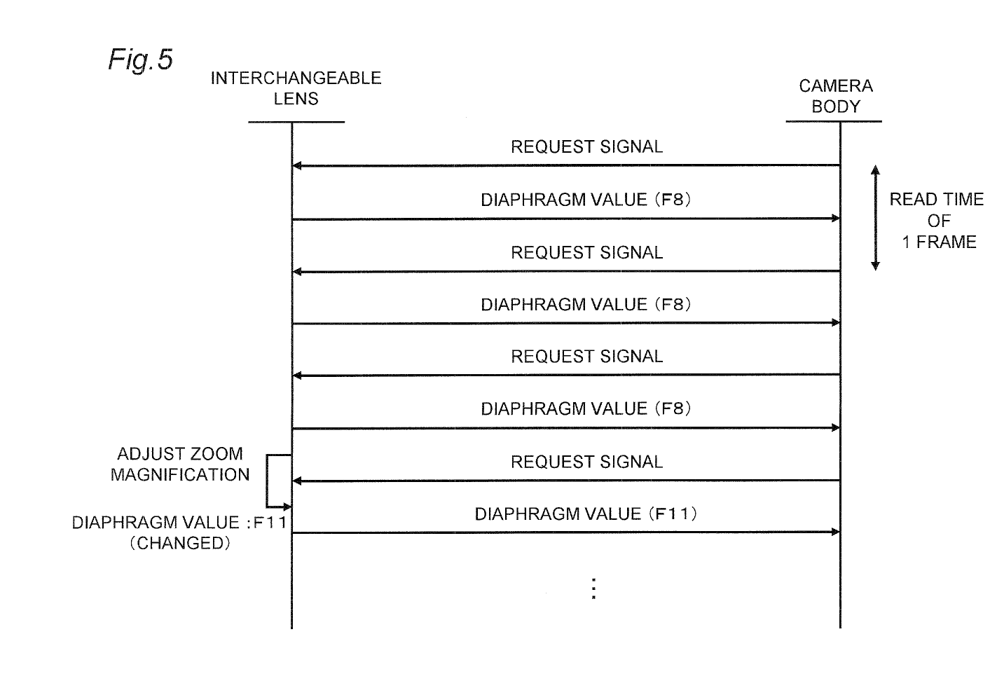

FIG. 5 shows the sending and receiving of a request signal and a diaphragm value which is a response to the request signal, performed between the CPU 211 of the camera body 2 and the lens controller 311 of the interchangeable lens 3. The camera body 2 sends a request signal to the interchangeable lens 3 on a frame-by-frame basis, i.e., according to a vertical synchronizing signal. When the interchangeable lens 3 receives the request signal, the interchangeable lens 3 calculates a diaphragm value and sends the calculated diaphragm value to the camera body 2. This operation is performed on a frame-by-frame basis.

As shown in FIG. 3, a diaphragm value is determined based on a position of the zoom lens 309 and an aperture of the diaphragm 307. Therefore, even when the camera body 2 specifies the diaphragm value “F8” to the interchangeable lens 3 and the interchangeable lens 3 adjusts the opening of the diaphragm 307 according to the specified diaphragm value “F8”, if the user changes the zoom magnification by operating the zoom ring 309, then the diaphragm value changes. For example, the diaphragm value changes from “F8” to “F11”. However, according to the present embodiment, since a diaphragm value is obtained from the interchangeable lens 3 at each timing at which a request signal is sent (i.e., on a frame-by-frame basis), the camera body 2 can immediately recognize that the diaphragm value has been changed.

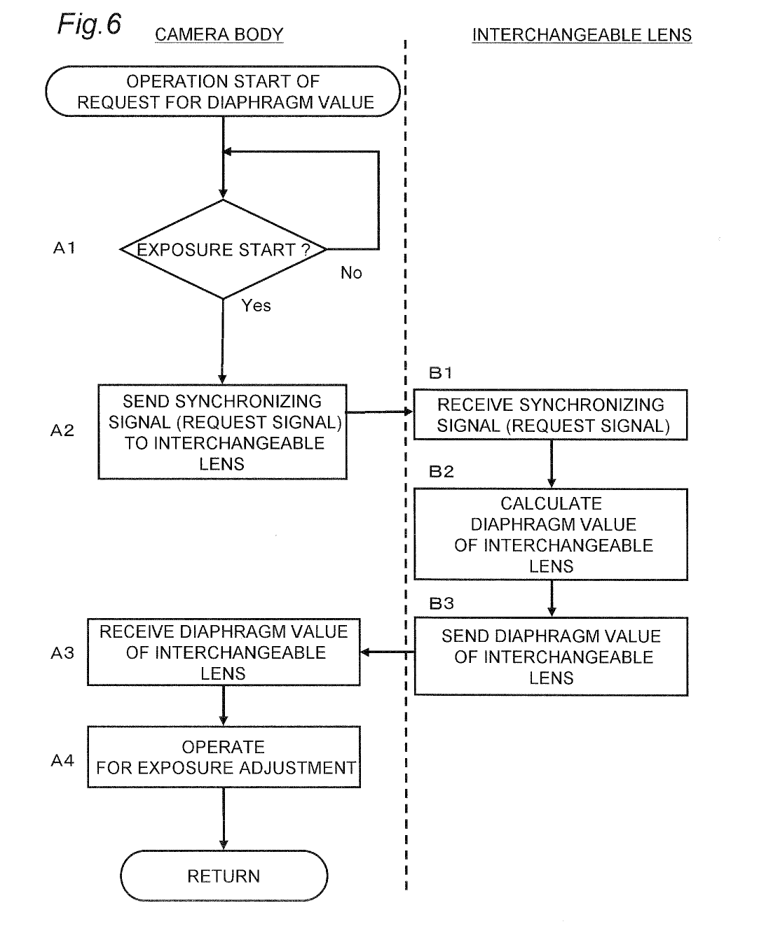

FIG. 6 is a flowchart of control performed by the CPU 211 of the camera body 2 and the camera controller 311 of the interchangeable lens 3. Using FIG. 6, description is made of a state, as an example, in which a signal specifying the diaphragm value “F8” is sent from the camera body 2 to the interchangeable lens 3, as a control signal for adjusting exposure and the interchangeable lens 3 adjusts the diaphragm 307 according to the diaphragm value “F8” (i.e., an already set diaphragm value=F8).

The camera body 2 (CPU 211) determines whether the CMOS sensor 201 has started exposure (A1). If the camera body 2 determines that the CMOS sensor 201 has started exposure (Yes in step A1), then the camera body 2 sends, as a request signal, a synchronizing signal to the interchangeable lens 3 (A2). When the interchangeable lens 3 receives the request signal (B1), the interchangeable lens 3 calculates a diaphragm value of the interchangeable lens 3, based on the diaphragm value table shown in FIG. 3 (B2). The interchangeable lens 3 sends the calculated diaphragm value to the camera body 2 (B3). The camera body 2 receives the diaphragm value of the interchangeable lens 3 (A3) and performs an operation for exposure adjustment, based on the received diaphragm value (A4).

### 2-1 Examples of Operation for Exposure Adjustment

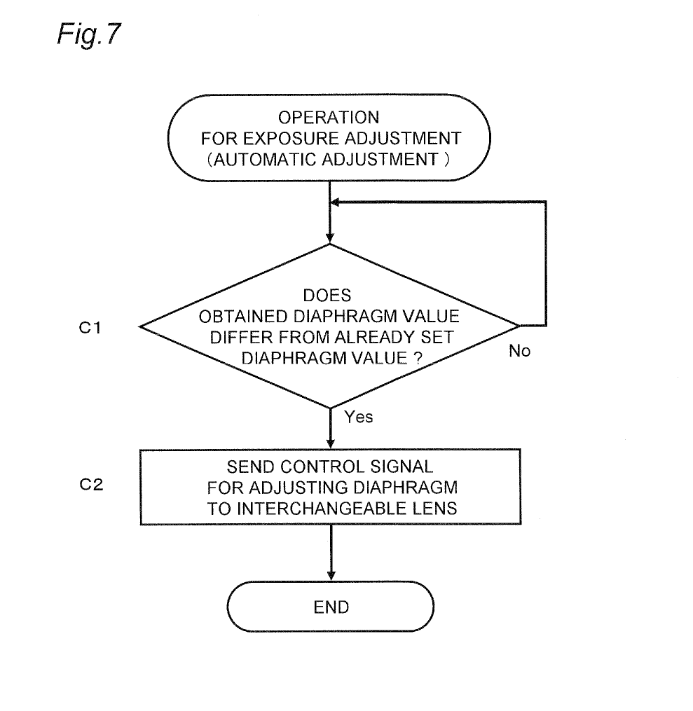

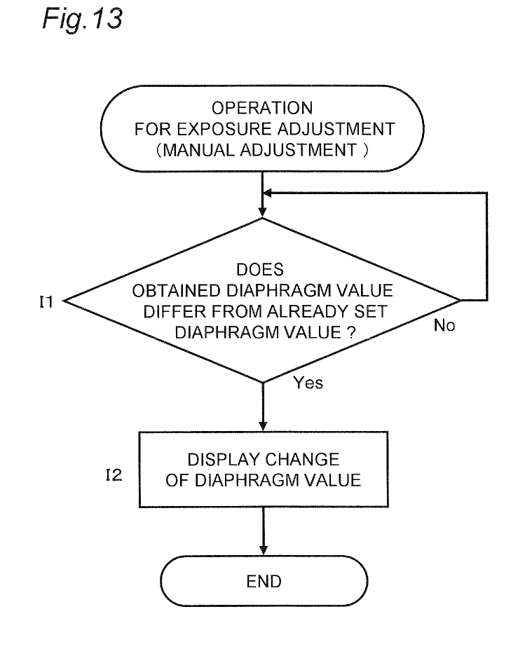

With reference to FIGS. 7 to 13, some examples of the operation for exposure adjustment (step A4) will be described below. FIGS. 7 to 12 each show an operation performed when the digital camera 1 automatically adjusts exposure, according to a changed diaphragm value. FIG. 13 shows an operation performed when the user is allowed to manually adjust exposure, according to a changed diaphragm value.

FIG. 7 shows an operation performed when the diaphragm is adjusted on the side of the interchangeable lens 3 to adjust exposure. The camera body 2 (CPU 211) determines whether a received diaphragm value differs from an already set diaphragm value (C1). For example, in the case of FIG. 5, the camera body 2 has the diaphragm value “F8” stored in the flash memory 209 and determines whether an obtained diaphragm value “F11” differs from the already set diaphragm value “F8”. If the camera body 2 determines that an obtained diaphragm value differs from an already set diaphragm value, then the camera body 2 adjusts the diaphragm 307 of the interchangeable lens 3. Specifically, the CPU 211 sends a control signal for adjusting an exposure state, particularly, the diaphragm (including a diaphragm value), to the interchangeable lens 3 (C2).

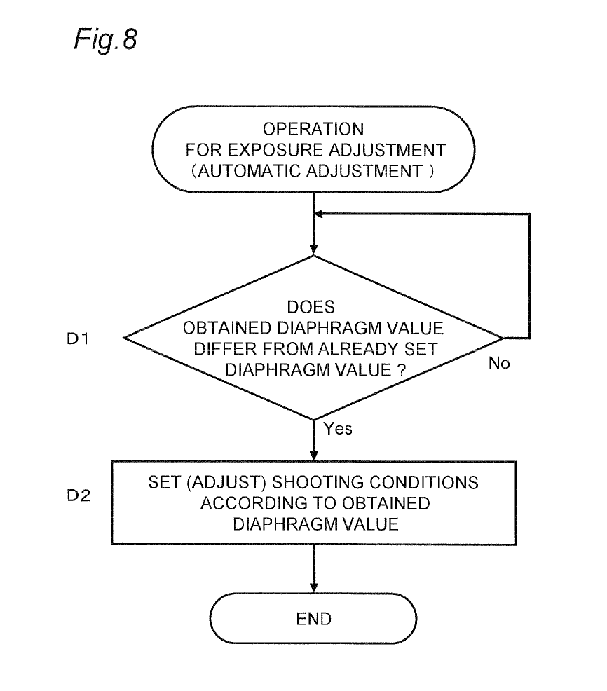

FIG. 8 shows an operation performed when the shooting conditions are adjusted on the side of the camera body 2 to adjust exposure. The camera body 2 (CPU 211) determines whether a received diaphragm value differs from an already set diaphragm value (D1). If the camera body 2 determines that an obtained diaphragm value differs from an already set diaphragm value, then the camera body 2 sets (adjusts) the shooting conditions, according to the obtained diaphragm value (D2). The shooting conditions include, for example, the sensitivity of the AGC and/or the light-receiving time of the light-receiving element in the CMOS sensor 201. Specifically, when the CPU 211 adjusts the shooting conditions of the CMOS sensor 201, the CPU 211 sets the shooting conditions according to the obtained diaphragm value, to obtain an already set amount of exposure according to a brightness of a subject in immediately previous image data. This is performed because due to the change in the diaphragm value of the interchangeable lens 3, the amount of exposure of the CMOS sensor 201 is changed. For example, the sensitivity of the AGC and/or the light-receiving time of the light-receiving element in the CMOS sensor 201 is(are) adjusted such that the CMOS sensor 201 obtains an already set amount of exposure. That is, the exposure sensitivity of the CMOS sensor 201 and the exposure time per frame are adjusted.

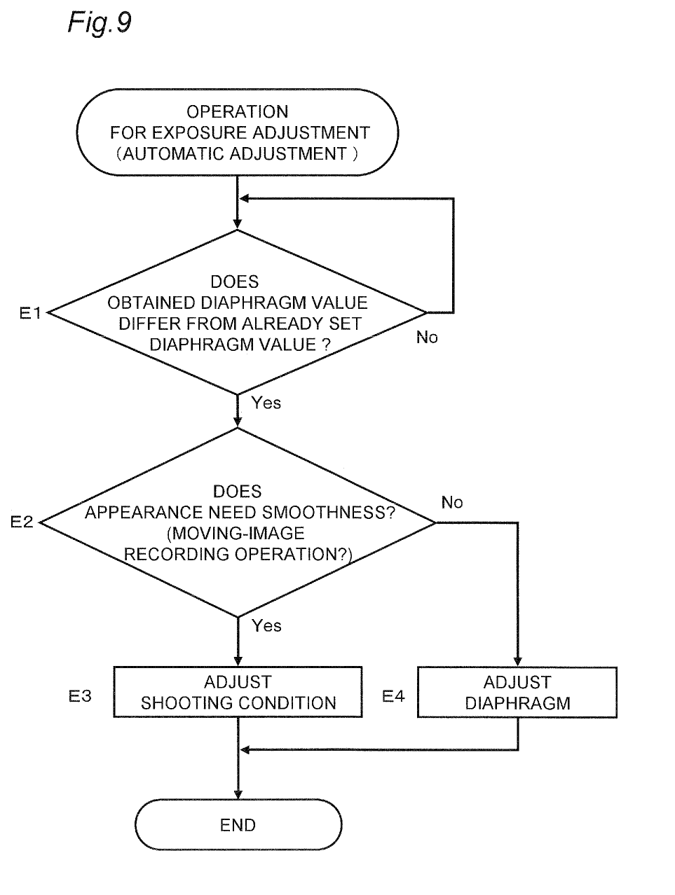

FIGS. 9 to 12 each show an operation performed when switching between an adjustment to the shooting conditions on the side of the camera body 2 (FIG. 8) and an adjustment to the diaphragm on the side of the interchangeable lens 3 (FIG. 7) is performed based on a predetermined condition. Switching between an adjustment to the shooting conditions and an adjustment to the diaphragm is performed, as shown in FIGS. 9 to 12, based on a predetermined condition (steps E2, F2, G2, and H2). In this case, shooting condition adjustment steps (steps E3, F3, G3, and H4) in FIGS. 9 to 12 are the same as step D2 in FIG. 8, and diaphragm adjustment steps (steps E4, F4, G4, and H3) in FIGS. 9 to 12 are the same as step 22 in FIG. 7. Also, in FIGS. 7 to 12, steps (C1, D1, E1, F1, G1, and H1) of comparing an obtained diaphragm value with an already set diaphragm value are the same.

FIG. 9 shows an operation performed when switching between an adjustment to the shooting conditions and an adjustment to the diaphragm is performed based on whether captured image data needs to have a smooth appearance. When image data needs to have a smooth appearance refers to, for example, when a moving image generated by the CMOS sensor 201 is recorded and saved in the flash memory 209 (or the memory card 218) (that is, during recording a moving image). When the camera body is recording a moving image, if the brightness varies among image frames composing the moving image, then the moving image to be recorded turns out to be a difficult-to-see moving image for the user. For example, when the camera body 2 is recording a moving image, if an adjustment to the diaphragm 307 is made according to drive of the zoom lens 303, since it takes time to drive the diaphragm 307 to a target aperture, in some cases, the brightness may vary among image frames. Hence, during recording a moving image, for example, it is preferable not to adjust the diaphragm 307. In FIG. 9, if the camera body 2 determines that an obtained diaphragm value differs from an already set diaphragm value (Yes in step E1), then the CPU 211 determines whether image data generated by the CMOS sensor 201 needs smoothness (E2). That is, the CPU 211 determines whether the camera body 2 is recording a moving-image. If the CPU 211 determines that the camera body 2 is recording a moving-image, then an adjustment to the diaphragm on the side of the interchangeable lens 3 is not performed but an adjustment to the shooting conditions is made on the side of the camera body 2 (E3). On the other hand, if the CPU 211 determines that the camera body 2 is not recording a moving-image, then an adjustment to the diaphragm on the side of the interchangeable lens 3 is made (E4). By this, the camera body 2 can further reduce degradation in the appearance of recorded moving image.

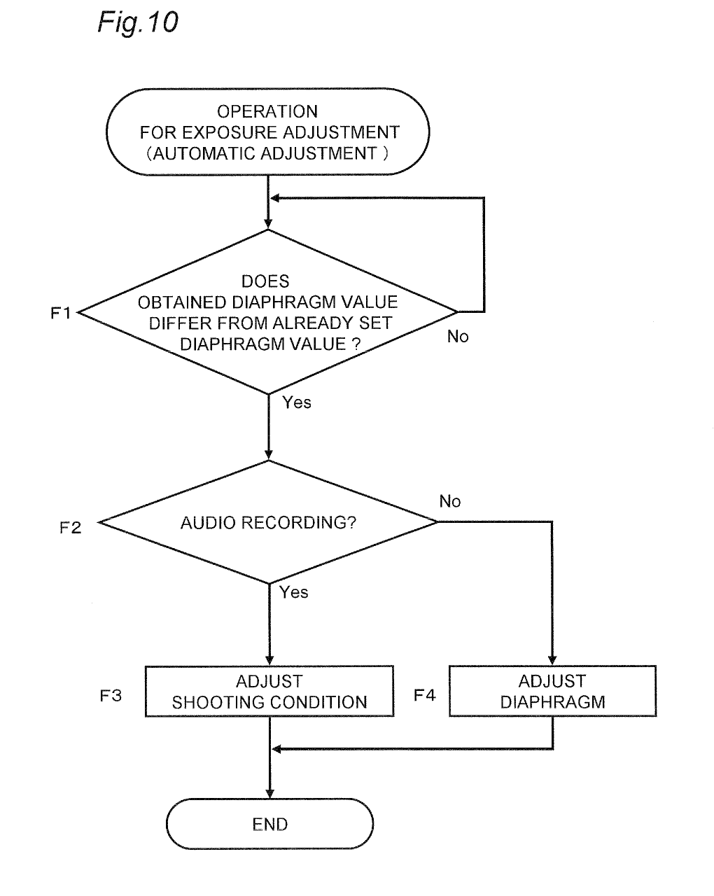

FIG. 10 shows an operation performed when switching between an adjustment to the shooting conditions (FIG. 8) and an adjustment to the diaphragm (FIG. 7) is performed based on whether the camera body 2 is in the middle of audio recording. When audio is obtained by the microphone 214 of the camera body 2 and the obtained audio is stored in the flash memory 209, if the diaphragm 307 of the interchangeable lens 3 is driven, then drive sound is recorded and the drive sound becomes noise. It is preferable that such noise is reduced as much as possible. Hence, if an obtained diaphragm value differs from an already set diaphragm value (Yes in step E1), then the CPU 211 determines whether the camera body 2 is in the middle of an audio recording operation (F2). If the CPU 211 determines that the camera body 2 is in the middle of an audio recording operation, then the CPU 211 adjusts the shooting conditions on the side of the camera body 2 (F3). On the other hand, if the CPU 211 determines that the camera body 2 is not in the middle of an audio recording operation, then the CPU 211 adjusts the diaphragm on the side of the interchangeable lens 3 (F4). Accordingly, noise can be further prevented from being stored as audio upon audio recoding.

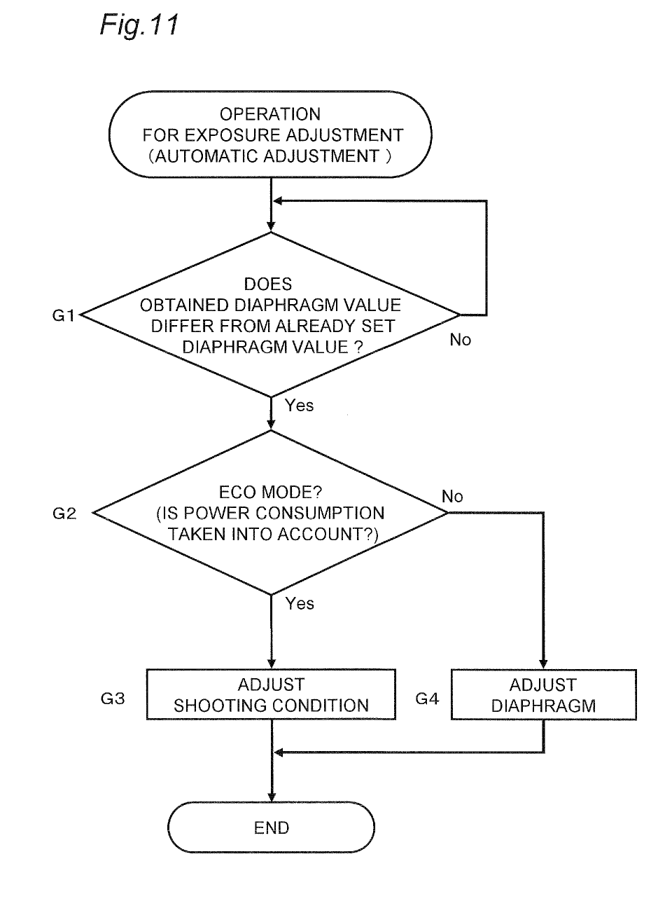

FIG. 11 shows an operation performed when switching between an adjustment to the shooting conditions (FIG. 8) and an adjustment to the diaphragm (FIG. 7) is performed based on whether the camera body 2 is in an eco mode (power-saving mode). In this case, the digital camera 1 is configured to be able to be switched between a power-saving mode and another mode by operating an operation member provided to the camera body 2. Since the camera body 2 and the interchangeable lens 3 operate by power being supplied thereto from the power supply 207 (a battery, and so on), if the power to be consumed can be reduced, then a long time operation is enabled. Hence, if an obtained diaphragm value differs from an already set diaphragm value (Yes in step G1), then the CPU 211 determines whether the mode set on the camera body 2 is a power-saving mode (G2). If the CPU 211 determines that a power-saving mode is set, then the CPU 211 adjusts the shooting conditions on the side of the camera body 2 (G3). On the other hand, if the CPU 211 determines that a power-saving mode is not set, then the CPU 211 adjusts the diaphragm 307 on the side of the interchangeable lens 3 (G4). Therefore, when a power-saving mode is set, the diaphragm drive unit 308 on the side of the interchangeable lens 3 is not driven and thus the power to be consumed by the diaphragm drive unit 308 can be reduced, enabling to reduce the power consumption of the entire digital camera.

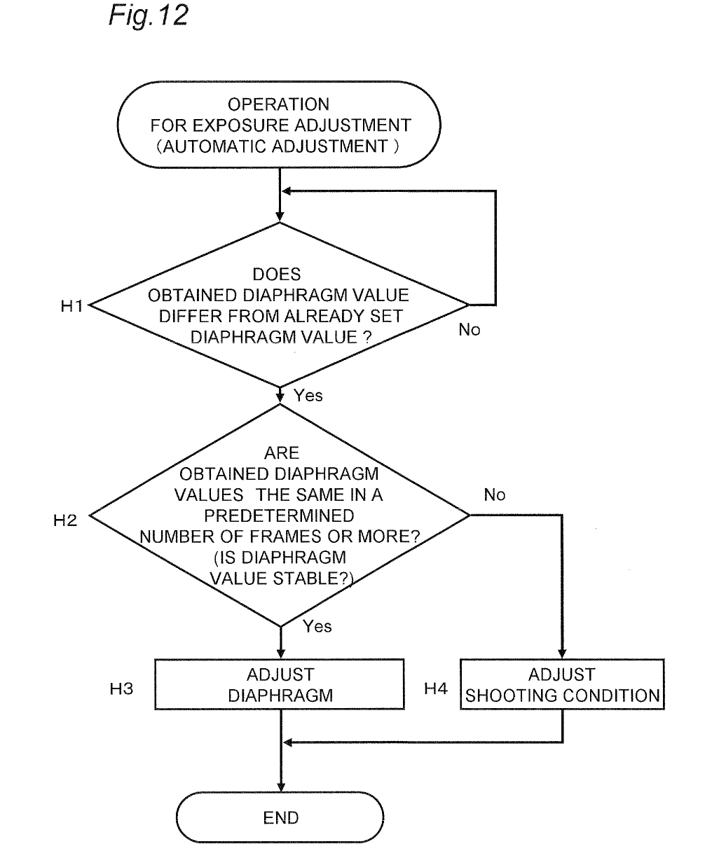

FIG. 12 shows an operation performed when switching between an adjustment to the shooting conditions (FIG. 8) and an adjustment to the diaphragm (FIG. 7) is performed based on whether the diaphragm value is stable. When the shooting conditions (sensitivity and light-receiving Lime) of the CMOS sensor 201 are changed, problems such as those shown below may occur.

For example, when sensitivity is increased, noise is more likely to occur. In the case in which, when light-receiving time is increased, a subject is a moving object, the subject in image data results in a blurred image. Hence, in such cases, desired image data is obtained by adjusting the diaphragm on the side of the interchangeable lens 3 rather than by adjusting the shooting conditions on the side of the camera body 2. Thus, for example, there is a case in which an “aperture priority mode”, in which while the diaphragm value is fixed other conditions are adjusted, is provided on the digital camera 1. Taking into account power consumption and the durability of the diaphragm, it is preferable to make an adjustment to the diaphragm 307 only when a zoom adjustment is completed and the diaphragm value is stabilized. On the other hand, even if taking into account power consumption and the like, when the diaphragm 307 of the interchangeable lens 3 is stable, it is preferable in some cases that the CPU 211 controls to adjust the diaphragm.

Hence, if an obtained diaphragm value differs from an already set diaphragm value (Yes in step H1), then the CPU 211 determines whether the obtained diaphragm value matches those in a predetermined number of frames or more that are sent in the past (H2). That is, the CPU 211 determines whether the diaphragm value is stable. The predetermined number of frames is, for example, 10 frames. If the CPU 211 determines that the obtained diaphragm value matches those in a predetermined number of frames or more, then the CPU 211 adjusts the diaphragm (H3). On the other hand, if the CPU 211 determines that the obtained diaphragm value does not match those in a predetermined number of frames or more, then the CPU 211 adjusts the shooting conditions (H4). Thus, while power consumption and the like, are taken into account, a more desirable image can be obtained.

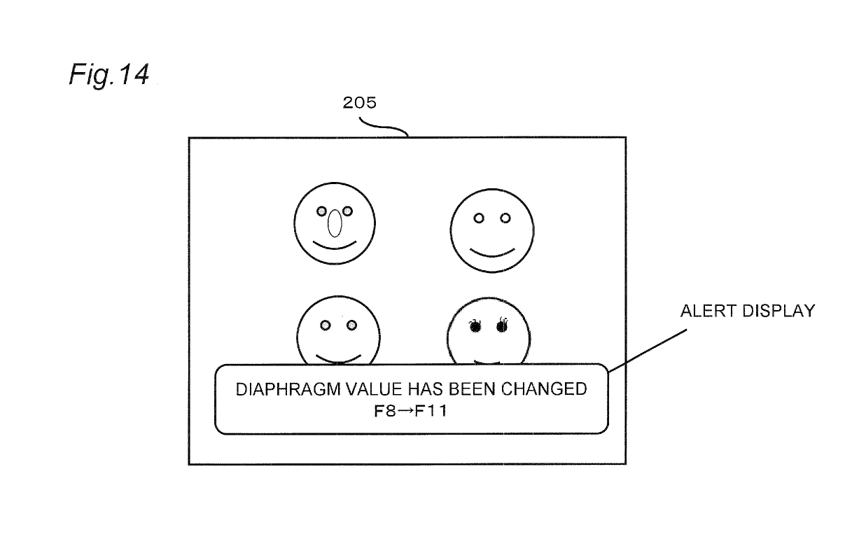

FIG. 13 shows an operation performed when a message notifying about a change in diaphragm value is displayed when an obtained diaphragm value differs from an already set diaphragm value. Exemplary display of the message is shown in FIG. 14. If an diaphragm value obtained from the interchangeable lens 3 differs from an already set diaphragm value (Yes in step I1), then the CPU 211 displays, as shown in FIG. 14, a message notifying that the diaphragm value has been changed, on a screen of the liquid crystal monitor 205 (I2). In this manner, an alert may be displayed for the user to urge the user to adjust the diaphragm value. According to the displayed alert, the user can manually adjust the diaphragm value by, for example, operating the operation member of the camera body 2.

### 3. Conclusions

According to the digital camera 1, the camera body 2 requests the interchangeable lens 3 to send information on the brightness of the interchangeable lens 3 on a synchronizing-signal-by-synchronizing-signal basis (i.e., on a frame-by-frame basis) and the interchangeable lens 3 sends information on the brightness of the interchangeable lens 3 to the camera body 2 on a synchronizing-signal-by-synchronizing-signal basis. Thus, even when the diaphragm value is changed by the user adjusting the zoom on the side of the interchangeable lens 3, the camera body 2 is able to know the changed diaphragm value. Thus, exposure control of the imaging element can be smoothly performed for plural pieces of image data which are sequentially generated by the imaging element (e.g., moving images).

Also, how an exposure adjustment is made is switched between an adjustment to the shooting conditions on the side of the camera body 2 and an adjustment to the diaphragm 307 of the interchangeable lens 3, based on a predetermined condition (whether the camera body 2 is in the middle of shooting a moving image or whether the camera body 2 is in the middle of audio recording or whether the camera body 2 is in an eco mode or whether the diaphragm value is stable), whereby a more appropriate exposure adjustment can be made.

### 4. Other embodiments

Although in the present embodiment the CMOS sensor 201 is used as an imaging unit, the imaging unit can be of any configuration as long as the imaging unit can image a subject image and can thereby generate image data (a digital signal or electrical signal). That is, although the camera body 2 includes the CMOS sensor 201 including a light-receiving element, an AGC, and an AD converter, the configuration is not limited thereto; for example, the camera body 2 may include a CCD image sensor and an AD converter that are configured by different members. Note that when the imaging unit is configured by the CMOS sensor 201, power consumption can be reduced.

Also, although in the present embodiment a diaphragm value of the interchangeable lens 3 is calculated based on a zoom position of the zoom lens 303 and a diaphragm of the diaphragm 307, the calculation of a diaphragm value is not limited to that according to the present embodiment. For example, a diaphragm value may be obtained using a focus position of the focus lens 304 instead of using a zoom position of the zoom lens 303. Alternatively, a diaphragm value may be obtained using a zoom position of the zoom lens 303 and a focus position of the focus lens 304. Although a diaphragm value is obtained by storing the diaphragm value table shown in FIG. 3 in the flash memory 312, the configuration is not limited thereto and a diaphragm value may be obtained by a computational expression.

Although in the present embodiment a synchronizing signal is used as a request signal, the request signal is not limited to a synchronizing signal. For example, the CPU 211 may detect that image data has been sent to the signal processing processor 203 from the CMOS sensor 201, and send a request signal to the interchangeable lens 3 at the detecting timing.

Although in the present embodiment whether the exposure state needs to be adjusted is determined by the determining unit 23 of the camera body 2 determining whether an obtained diaphragm value differs from an already set diaphragm value, the configuration is not limited thereto. A determination as to whether the exposure state needs to be adjusted can be made in any manner as long as the determination is made according to information on brightness which is obtained by the determining unit 23. For example, when an obtained diaphragm value is changed, the determining unit 23 may determine whether to adjust the exposure state, according to the amount of change from an already set diaphragm value. In this case, for example, when the diaphragm value is changed to a predetermined value or more, it is determined that the exposure state needs to be adjusted.

In the present embodiment, as shown in FIGS. 9-11, the shooting conditions are adjusted at the determined step (steps E3, F3, and G3), and the diaphragm is adjusted at the determined step (steps E4, F4, and G4). However, the adjustment is not limited thereto. At the determined step (steps E3, F3, and G3), at least one of the shooting conditions and the diaphragm may be adjusted as long as the shooting conditions may be preferentially adjusted. Also, at the determined step (steps E4, F4, and G4), at least one of the diaphragm and the shooting conditions may be adjusted as long as the diaphragm may be preferentially adjusted. When the shooting conditions are preferentially adjusted, an amount of the adjustment of the exposure state according to the shooting conditions can be larger than that according to the diaphragm. Similarly, when the diaphragm is preferentially adjusted, an amount of the adjustment of the exposure state according to the diaphragm can be larger than that according to the shooting conditions. The amount of the adjustment of the exposure state is, for example, magnitude of affecting the EV value.

The reasons of the above-mentioned control of the shooting conditions and the diaphragm are as follows. For example, if the camera body adjusts the exposure state by controlling the diaphragm at the step E4, in some cases, the exposure state can not be adjusted to the desired exposure state when the camera body controls the diaphragm to the limit. Thus, the camera body needs to control the shooting conditions in addition to the control of the diaphragm in order to obtain the suitable exposure state. Accordingly, in another embodiment, for example, when the camera body determines that the exposure state can not be adjusted to the desired state upon controlling only the diaphragm, the shooting conditions are adjusted in addition to the adjustment of the diaphragm. This enables the camera body to perform the suitable exposure control.

The other embodiment is not limited to FIGS. 9-12 and the following configuration may be used when the obtained diaphragm value differs from the already set diaphragm value. For example, (1) the control may be changed based on whether or not a flicker occurs in image data generated by the CMOS image sensor 201, or (2) the control may be changed based on whether or not a whiteout condition (electric charge saturation) occurs in image data generated by the CMOS image sensor 201. The both controls will be explained briefly in order.

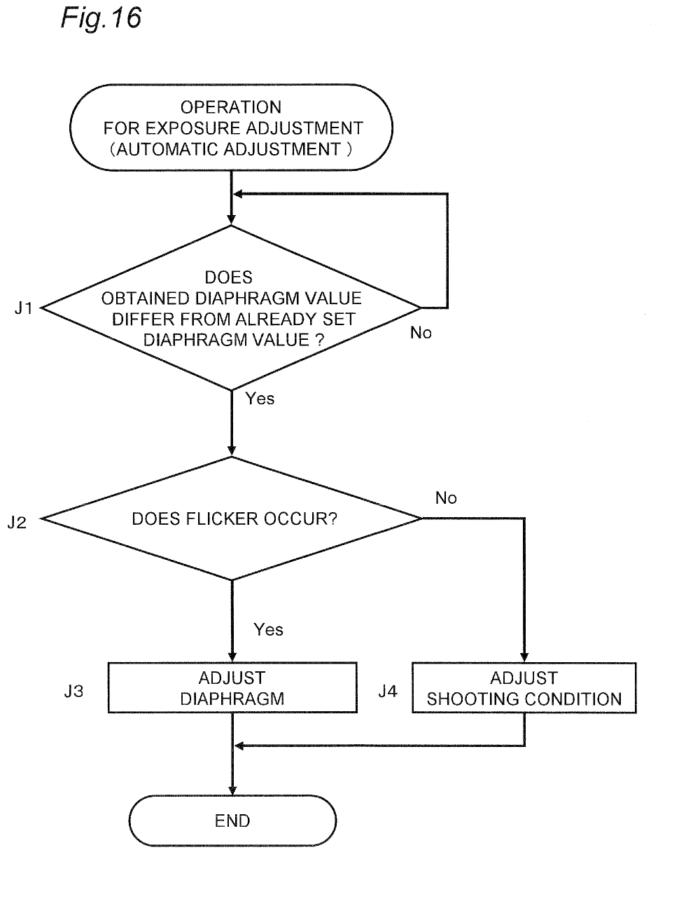

(1) The following is explanation of a case that the control may be changed based on whether or not a flicker occurs in the CMOS image sensor, using the FIG. 16. FIG. 16 shows an operation of switching between the adjustment of the shooting conditions (FIG. 8) and the adjustment of the diaphragm (FIG. 7) based on whether or not a flicker occurs in image data generated by the CMOS image sensor.

When a flicker occurs or the imaging is performed under a fluorescent lamp, if the camera body 2 shortens the exposure time, a flicker in the image data becomes highly visible. Thus, when a flicker occurs in the image data, if the camera body 2 suppresses the shortening of the exposure time, more desirable image data can be provided for the user. When the obtained diaphragm value differs from the already set diaphragm value (Yes at step J1), the CPU 211 determines whether or not a flicker occurs in image data generated by the CMOS image sensor (J2). When the CPU 211 determines that the flicker occurs, it adjusts the diaphragm 307 in the interchangeable lens 3 (J3). When the CPU 211 determines that the flicker does not occur, it adjusts the shooting conditions in the camera body 2 (J4). In this way, when the flicker occurs, the diaphragm drive unit 308 in the interchangeable lens 3 is driven to prevent the shorter exposure time. Accordingly, more desirable moving image can be provided for the user. The CPU 211 may preferentially control the diaphragm similarly to the above other embodiment.

The determination whether or not the flicker occurs in the image data can be made using a known technique, and the detail explanation is omitted.

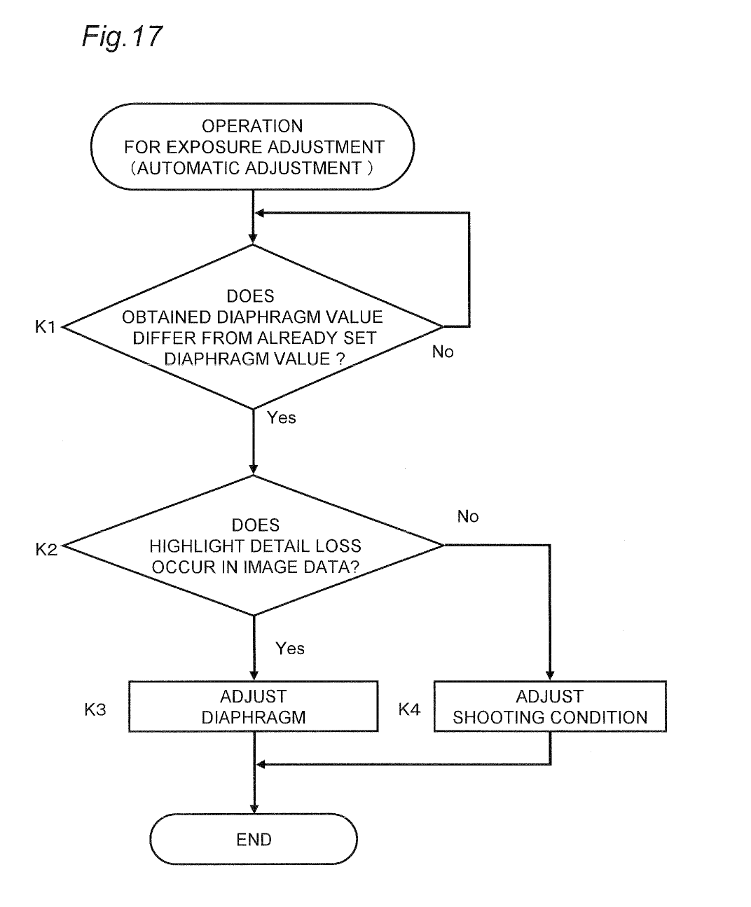

(2) The following is explanation of the case that the control may be changed based on whether or not electric charge saturation occurs in the CMOS image sensor, using the FIG. 17. FIG. 17 shows an operation of switching between the adjustment of the shooting conditions (FIG. 8) and the adjustment of the diaphragm (FIG. 7) based on whether or not highlight detail loss occurs in image data generated by the CMOS image sensor. In the camera body 2, when highlight detail loss occurs in image data generated by the CMOS image sensor 201 or electric charge saturation occurs in the CMOS image sensor 201, electric charge saturation in a pixel may affect the electric charge in other pixel (In a case of the CCD, smear occurs). Thus, when the camera body 2 determines that highlight detail loss occurs in image data generated by the CMOS image sensor 201, if the camera body 2 suppresses the shortening of the exposure time, more desirable image data can be provided for the user. When the obtained diaphragm value differs from the already set diaphragm value (Yes at step K1), the CPU 211 determines whether or not highlight detail loss occurs in image data generated by the CMOS image sensor. When the CPU 211 determines that the highlight detail loss occurs, it adjusts the diaphragm 307 in the interchangeable lens 3 (K3). When the CPU 211 determines that the highlight detail loss does not occur, it adjusts the shooting conditions in the camera body 2 (K4). In this way, when the highlight detail loss occurs, the diaphragm drive unit 308 in the interchangeable lens 3 is driven in the exposure time to prevent the shorter exposure time. Accordingly, more desirable moving image can be provided for the user. The CPU 211 may preferentially control the diaphragm similarly to the above other embodiment.

The determination whether or not the highlight detail loss occurs in image data can be made using a known technique, and the detail explanation is omitted.

Although in the present embodiment the interchangeable lens 3 is a lens for a digital still camera which is mountable to a digital still camera, the interchangeable lens 3 is not limited thereto. For example, the interchangeable lens 3 may be a lens for a digital video camera mountable to a digital video camera or may be a lens mountable to both a digital still camera and a digital video camera.

Although the present embodiment has been described in connection with specified embodiments thereof, many other modifications, corrections and applications are apparent to those skilled in the art. Therefore, the embodiment is not limited by the disclosure provided herein but limited only to the scope of the appended claims. The present disclosure relates to subject matter contained in Japanese Patent Application No. 2008-112343, filed on Apr. 23, 2008, which is expressly incorporated herein by reference in its entirety.

### INDUSTRIAL APPLICABILITY

The embodiment has an advantageous effect that even when the diaphragm value is changed by a user adjusting the zoom on the interchangeable lens side, appropriate exposure control can be performed and thus is useful for an interchangeable lens mountable to a camera body, a camera body on which the interchangeable lens is mountable, and an imaging apparatus including the interchangeable lens and the camera body.

1. An interchangeable lens mountable to a camera body that includes an imaging unit operable to capture a subject image, the interchangeable lens comprising:
a diaphragm;
a movable lens;
a request signal receiving unit operable to receive a request signal from the camera body;
a brightness information calculating unit operable to calculate information on brightness of the interchangeable lens based on states of the diaphragm and the movable lens when the request signal receiving unit receives the request signal; and
a brightness information sending unit operable to send the calculated information on brightness of the interchangeable lens to the camera body, wherein
the request signal is a signal that is sequentially transmitted from the camera body in accordance with a timing of the imaging unit for capturing the subject image.

2. The interchangeable lens according to claim 1, wherein the movable lens is one of a zoom lens and a focus lens.

3. A camera body to which an interchangeable lens is mountable, the camera body comprising:
an imaging unit operable to capture a subject image;
a request signal sending unit operable to send a request signal to the interchangeable lens in accordance with a timing of the imaging unit for capturing the subject image;
a brightness information receiving unit operable to receive information on brightness of the interchangeable lens which is sent from the interchangeable lens in response to receiving the request signal;
a determining unit operable to determine whether an exposure state needs to be adjusted according to the received information on brightness; and
an adjusting unit operable to adjust the exposure state by controlling at least one of the interchangeable lens or the camera body according to a result of the determination made by the determining unit.

4. The camera body according to claim 3, wherein the adjusting unit adjusts the exposure state by preferentially-controlling the camera body when the imaging unit generate moving-images.

5. The camera body according to claim 3, wherein the adjusting unit adjusts the exposure state by preferentially-controlling the camera body when the camera body performs audio recording.

6. The camera body according to claim 3, wherein the adjusting unit adjusts the exposure state by preferentially-controlling the camera body when a power-saving mode is set by the camera body.

7. The camera body according to claim 3, wherein the adjusting unit adjusts the exposure state by preferentially-controlling the interchangeable lens when generation of a flicker is detected in the camera body.

8. The camera body according to claim 3, wherein the adjusting unit adjusts the exposure state by preferentially-controlling the interchangeable lens when electric charge saturation of the imaging unit is detected in the camera body.

9. An imaging apparatus comprising:
an interchangeable lens including a diaphragm and a movable lens; and
a camera body to which the interchangeable lens is mountable, wherein
the interchangeable lens includes:
a request signal receiving unit operable to receive a request signal from the camera body;
a brightness information calculating unit operable to calculate information on brightness of the interchangeable lens based on states of the diaphragm and the movable lens when the request signal receiving unit receives the request signal; and
a brightness information sending unit operable to send the calculated information on brightness of the interchangeable lens to the camera body;
the camera body includes:
an imaging unit operable to capture a subject image;
a request signal sending unit operable to send a request signal to the interchangeable lens in accordance with a timing of the imaging unit for capturing the subject image;
a brightness information receiving unit operable to receive information on brightness of the interchangeable lens which is sent from the interchangeable lens in response to receiving the request signal;
a determining unit operable to determine whether an exposure state needs to be adjusted according to the received information on brightness; and
an adjusting unit operable to adjust the exposure state by controlling at least one of the interchangeable lens or the camera body according to a result of the determination made by the determining unit;
wherein the request signal is a signal that is sequentially transmitted from the camera body in accordance with a timing of the imaging unit for capturing the subject image.
